(19) United States
(12) Patent Application Publication
(10) Pub. No.: US 2026/0081057 A1
(43) Pub. Date: Mar. 19, 2026

(54) LOW-TEMPERATURE-RESISTANT MAGNETORHEOLOGICAL FLUID AND PREPARATION METHOD THEREOF

(71) Applicant: Chongqing Cicheng Technology Co., Ltd., Chongqing (CN)

(72) Inventors: Miao Yu, Chongqing (CN); Dan Wu, Chongqing (CN); Song Qi, Chongqing (CN); Jie Fu, Chongqing (CN)

(73) Assignee: Chongqing Cicheng Technology Co., Ltd., Chongqing (CN)

(21) Appl. No.: 19/328,221

(22) Filed: Sep. 14, 2025

(30) Foreign Application Priority Data
Apr. 29, 2025 (CN) 202510549367.7

(51) Int. Cl. H01F 1/44

(52) U.S. Cl. CPC H01F 1/447

(57) ABSTRACT

This application relates to the technical field of intelligent materials, in particular to a low-temperature-resistant magnetorheological fluid and a preparation method thereof. The method includes surface treatment of magnetic particles in a magnetorheological fluid This application has the effect of improving the low-temperature resistance of the magnetorheological fluid.

### TECHNICAL FIELD

This present disclosure relates to the technical field of smart materials, in particular to a low-temperature-resistant magnetorheological fluid and a preparation method thereof.

### BACKGROUND

At present, the magnetorheological fluid is an intelligent fluid composed of a base carrier fluid, magnetic particles, and additives. Its rheological properties can be rapidly and reversibly regulated by an external magnetic field, and it is widely used in dampers, precision polishing, and other fields.

The traditional magnetorheological fluid has the following problems in low-temperature environments: the viscosity of conventional mineral oil or silicone oil increases sharply or even solidifies below −30° C., resulting in a sharp change in magnetorheological properties. In addition, the high viscosity carrier liquid hinders the dynamic reorganization of the particle chain, and the magnetic field switching response time is prolonged. These problems lead to the fluctuation of the output performance of the damping device and affect the control effect. The existing technology partially improves the low-temperature performance by adding anticoagulants or adjusting the particle size. However, it is difficult to maintain stability below −40° C. Therefore, a magnetorheological fluid with low-temperature fluidity, high magnetorheological effect, and anti-settlement is urgently needed.

### SUMMARY

In order to improve the low-temperature resistance of magnetorheological fluid, this application provides a low-temperature-resistant magnetorheological fluid and a preparation method thereof.

In the first aspect, a low-temperature-resistant magnetorheological fluid provided in the present disclosure adopts the following technical scheme:

A low-temperature-resistant magnetorheological fluid is made of components containing the following parts by weight: 60-75 parts of magnetic particles; 3-15 parts of modified magnetic particles; 10-25 parts of low-temperature base carrier liquid, including 40-60% silicone oil and/or mineral oil, 20-30% synthetic ester, poly alpha olefin 10-20%; 0.1-1.0 parts of dispersant; 0.5-2.0 parts of anticoagulant; the modified magnetic particles are magnetic particles after SiO₂ aerogel coating and fluorine-containing silane grafting.

By adopting the above technical scheme, the low viscosity characteristics (−40° C. kinematic viscosity≤250 mPa s) of the composite base carrier liquid and the anticoagulant synergistic effect significantly inhibit the solidification of the carrier liquid; the core-shell structure of the modified magnetic particles (SiO₂ aerogel coating layer+fluorine-containing grafting layer) reduces particle agglomeration through physical adsorption and chemical hydrophobicity. Under the magnetic field, the shear yield stress is increased, and the magnetic response performance is improved. The high permeability of the core-shell particles and the fluidity of the base carrier fluid ensure the rapid recombination of the magnetic field-induced particle chains. The core-shell structure of the modified magnetic particles (SiO₂ aerogel buffers thermal stress, and the fluorine-containing graft layer reduces ice crystal adsorption) and the low-viscosity composite carrier fluid work together to significantly improve the low-temperature stability.

By limiting the ratio of magnetic particles, modified magnetic particles, low-temperature base carrier fluid (silicone oil/synthetic ester/poly alpha olefin composite system), dispersant and anticoagulant, the magnetorheological fluid has low viscosity (≤ 300 mPa·s) at −40° C., high settlement resistance (72 hours settlement rate≤10%) and strong magnetorheological effect (shear stress≥75 kPa at 800 mT).

In some embodiments, the SiO₂ aerogel coating thickness of the modified magnetic particles is 50-100 nm.

By adopting the above technical scheme, the thickness of the SiO₂ aerogel coating layer is 50-100 nm, and the high porosity (≥90%) and structural stability of the coating layer are maintained. The high porosity (≥90%) of SiO₂ aerogels can absorb the thermal expansion difference between the magnetic particles (such as carbonyl iron) and the base carrier liquid, avoid the coating layer rupture caused by the interfacial stress at low temperatures, inhibit the interfacial debonding at low temperatures, and avoid the loss of magnetic properties caused by being too thick. If the coating layer is too thin (<50 nm), it may not effectively isolate particles from direct contact with the carrier liquid, leading to interfacial oxidation; if the coating layer is too thick (>100 nm), the volume ratio of magnetic particles may be reduced, and the magnetorheological effect weakens.

In some embodiments, the dispersant is selected from polyether modified siloxane or hyperbranched polyester amide.

By adopting the above technical scheme, the dispersant is a polyether modified siloxane or hyperbranched polyester amide. The branched chain structure of polyether modified siloxane is adsorbed on the surface of the particles, forming a three-dimensional barrier, preventing the particles from gathering due to van der Waals force, forming a steric hindrance effect, preventing particles from gathering, and maintaining the uniformity of magnetorheological fluid; the polar groups of hyperbranched polyesteramide can increase the surface charge density of the particles and enhance the electrostatic repulsion.

In some embodiments, the anticoagulant is selected from an alkyl naphthalene derivative or a polymethacrylate.

By adopting the above technical scheme, the anticoagulant alkyl naphthalene derivatives (such as dodecyl naphthalene) or polymethacrylate can effectively reduce the freezing point of the base liquid (≤−60° C.), inhibit low-temperature crystallization, and the synergistic effect of the anticoagulant and the composite carrier liquid ensures low-temperature fluidity. Polymethacrylate reduces the intermolecular friction by adsorbing on the molecular chain of the carrier liquid.

In some embodiments, the particle size of the magnetic particles is 0.5-10 μm, and the magnetic particles are selected from at least one of carbonyl iron powder, cobalt powder, and nickel powder.

By adopting the above technical scheme, the particle size of magnetic particles is 0.5-10 μm, which ensures the balance between magnetic response speed and anti-settlement. The smaller particle size (such as 3 μm) has a higher specific surface area and accelerates the formation speed of the particle chain under a magnetic field. The larger particle size (such as 5 μm) is more likely to settle due to gravity, but the low settlement rate can still be maintained by coating and dispersing agents of modified particles. If the particle size is too small, it is easy to settle (such as 0.4 μm), and if the particle size is too large, it will reduce the magnetorheological effect (such as 11 μm).

In some embodiments, a contact angle of the fluorine-containing silane grafting of the modified magnetic particles is ≥110°.

By adopting the above technical scheme, the fluorine-containing silane grafting contact angle of the modified magnetic particles is ≥110°. The low surface energy characteristics of the fluorine-containing segments (such as perfluorodecyl) can reduce the nucleation of ice crystals on the surface of the particles and avoid the interface blockage at low temperatures. The hydrophobic layer reduces the friction resistance between the particles and the carrier liquid, and further improves the fluidity. It also endows the particles with superhydrophobicity, reduces the adsorption of low-temperature ice crystals on the surface of the particles, and avoids the decrease of fluidity caused by interface blockage.

In the second aspect, a preparation method for the low-temperature-resistant magnetorheological fluid provided by this application adopts the following technical scheme:

A preparation method for the low-temperature-resistant magnetorheological fluid includes the following steps:
a, immersing the magnetic particles in an ethanol solution of silane coupling agent, ultrasonically treating for 30 minutes, and drying at 80° C.;
b, adding the magnetic particles prepared in Step a with SiO₂ aerogel, stirred at 50-60° C. for 4-6 hours, and drying by supercritical drying after aging for 24 hours to form a SiO₂ aerogel coating layer;
c, in a vacuum reaction vessel, introducing the magnetic particles of the SiO₂ aerogel coating layer prepared by Step b into the fluorine-containing silane, and grating the gas phase at 120-150° C. for 2-4 hours to obtain the modified magnetic particles;
d, ultrasonic mixing 10-25 parts of the base liquid and 0.5-2.0 parts of the anticoagulant by weight at 40-60° C. for 30 minutes to form a mixture;
e, mixing 3-15 parts of the modified magnetic particles, a dispersant of 0.1-1.0 parts, and a magnetic particle of 60-75 parts by weight with the mixture prepared by Step d and dispersing by a micro-jet homogenizer;
f, the liquid prepared by Step e is subjected to gradient cooling treatment to obtain a magnetorheological fluid.

By using the above technical scheme, the surface activity of the particles is enhanced by silane coupling agent treatment, which provides an anchoring site for aerogel deposition. The aerogel coating provides a thermal buffer layer to improve the thermal buffer effect; the fluorine-containing silane grafting makes the fluorine group firmly grafted in the form of a covalent bond, improves the hydrophobicity, and comprehensively improves the dispersibility and low-temperature stability of the particles. The ultrasonic mixing of the base carrier liquid and the anticoagulant ensures uniform dispersion and reduces the low-temperature phase separation caused by uneven local concentration.

In some embodiments, in Step f, three-stage gradient cooling of 25° C., −20° C., and −40° C. is adopted, and each stage is kept for 2 hours.

By adopting the above technical scheme, gradient cooling (25° C.→−20° C.→−40° C.) can reduce the thermal stress mutation, which allows the carrier liquid molecules to gradually adjust the conformation, reduce the damage of thermal stress to the microstructure, and stabilize the microstructure of the magnetorheological fluid.

In some embodiments, in Step e, 60-75 parts of magnetic particles are processed by Step a.

By adopting the above technical scheme, the anti-settling of the particles is improved by treating the magnetic particles with a silane coupling agent.

In some embodiments, when the micro-jet homogenizer is used for dispersion in Step e, the shear rate is ≥10\hat{ }4s⁻¹, the pressure is 1500 bar, and three cycles of dispersion are performed.

By using the above technical scheme, the high shear force of the micro-jet homogenizer (≥10\hat{ }4s⁻¹, 1500 bar) makes the particles uniformly dispersed.

In summary, this application has the following beneficial technical effects: Through the synergistic effect of core-shell magnetic particles (carbonyl iron/cobalt/nickel core+SiO₂ aerogel/fluorine-containing polymer coating), low-viscosity composite carrier liquid system (silicone oil and/or mineral oil, synthetic ester, poly-α-olefin) and multi-level dispersion stabilizers, the SiO₂ aerogel interlayer buffers the difference in thermal expansion coefficient, inhibits low-temperature interfacial peeling, and the fluorine-containing graft layer reduces ice crystal adsorption, significantly reduces low-temperature viscosity, and improves the flow performance of magnetorheological fluid.

### DETAILED DESCRIPTION OF THE EMBODIMENTS

The following is a further explanation of this application.

This application example discloses a low-temperature-resistant magnetorheological fluid and a preparation method thereof. In the implementation example, the experimental methods used are conventional methods without special instructions, and the materials and reagents used can be obtained from commercial channels without special instructions.

Example 1: A low-temperature-resistant magnetorheological fluid of this example is made of the following weight components: magnetic particles are selected from 68 parts of carbonyl iron powder (D50=3 μm); modified magnetic particles: 12 parts of SiO₂ aerogel coating+perfluorodecyltriethoxysilane grafted carbonyl iron powder; 18 parts of base carrier liquid: containing dimethyl silicone oil (50%)+pentaerythritol ester (30%)+PAO6 (20%); 0.5 parts of polyether modified siloxane dispersant; 1.5 parts of anticoagulant dodecyl naphthalene.

The preparation method for a low-temperature-resistant magnetorheological fluid of this example includes the following steps:
a, the magnetic particles are immersed in the ethanol solution of silane coupling agent (KH550), ultrasonically treated for 30 minutes, and dried at 80° C.; the magnetic particles are carbonyl iron powder;
b, the magnetic particles prepared in Step a are added with SiO₂ aerogel, stirred at 55° C. for 5 hours, and dried in supercritical fluid after aging for 24 hours to form a SiO₂ aerogel coating layer;
c, in the vacuum reaction vessel, the magnetic particles of the SiO₂ aerogel coating layer prepared by Step b are introduced into the perfluorodecyltriethoxysilane, and the modified magnetic particles are prepared by gas phase grafting at 150° C. for 2 hours;
specifically, the SiO₂ precursor solution (TEOS as the precursor, ammonia as the catalyst) is added drop by drop to the magnetic particles treated by Step a. The mass ratio of carbonyl iron powder to SiO₂ precursor is 1:10-1:5, and the weight ratio is selected as 1:7.5 in this example. This range can ensure the integrity and thickness controllability of the aerogel coating layer (controlled at 80 nm±5 nm). The mixture is stirred at 55° C. for 5 hours to complete hydrolysis and condensation. After aging for 24 hours, the SiO₂ aerogel coating layer is formed by supercritical drying, and the thickness is 80 nm. By adjusting the silane concentration (2-5 vol %, this example is preferably 3.5 vol %), the grafting time is 3 hours, and the temperature is 150° C., the surface energy is reduced to <20 mN/m, and the contact angle is≥110°.
d, 18 parts of the base liquid and 1.5 parts of the anticoagulant by weight are ultrasonically mixed at 50° C. for 30 minutes to form a mixture; the base carrier liquid contains dimethyl silicone oil (50%)+pentaerythritol ester (30%)+PAO6 (20%); dodecyl naphthalene is selected as the anticoagulant;
e, 12 parts of the modified magnetic particles, 0.5 parts of dispersant, 68 parts of magnetic particles by weight are mixed with the mixture prepared by Step d, and dispersed by the micro jet homogenizer, in which the shear rate is≥10\hat{ }4s⁻¹, the pressure is 1500 bar, and three cycles of dispersion are carried out; the dispersant is polyether modified siloxane; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

Example 2: A low-temperature-resistant magnetorheological fluid of this example is made of the following weight components: magnetic particles are selected from 68 parts of cobalt powder (D50=3 μm); modified magnetic particles: 12 parts of SiO₂ aerogel coating+perfluorodecyltriethoxysilane grafted cobalt powder; 18 parts of base carrier liquid: containing phenyl silicone oil (55%)+trimethylolpropane ester (25%)+PAO4 (20%); 0.8 parts of hyperbranched polyester amide dispersant; 1.2 parts of anticoagulant polymethacrylate.

The preparation method for a low-temperature-resistant magnetorheological fluid of this embodiment includes the following steps:
a, the magnetic particles are immersed in the ethanol solution of silane coupling agent (KH550), ultrasonically treated for 30 minutes, and dried at 80° C.; the magnetic particles are cobalt powder;
b, the magnetic particles prepared in Step a are added with SiO₂ aerogel, stirred at 55° C. for 5 hours, and dried in supercritical fluid after aging for 24 hours to form a SiO₂ aerogel coating layer;
c, in the vacuum reaction vessel, the magnetic particles of the SiO₂ aerogel coating layer prepared by Step b are introduced into the perfluorodecyltriethoxysilane, and the modified magnetic particles are prepared by gas phase grafting at 150° C. for 2 hours;
specifically, the SiO₂ precursor solution (TEOS as the precursor, ammonia as the catalyst) was added drop by drop to the magnetic particles treated by step a. The mass ratio of cobalt powder to SiO₂ precursor is 1:10-1:5, and the weight ratio was selected as 1:7.5 in this example. This range can ensure the integrity and thickness controllability of the aerogel coating layer (controlled at 80 nm±5 nm). The mixture is stirred at 55° C. for 5 hours to complete the hydrolysis condensation. After aging for 24 hours, the SiO₂ aerogel coating layer is formed by supercritical drying, and the thickness is 80 nm. By adjusting the silane concentration (2-5 vol %, this example is preferably 3.5 vol %), the grafting time is 3 hours, and the temperature is 150° C., the surface energy is reduced to <20 mN/m, and the contact angle is ≥110°.
d, 18 parts of the base liquid and 1.2 parts of the anticoagulant by weight are ultrasonically mixed at 50° C. for 30 minutes to form a mixture; the base carrier liquid contains phenyl silicone oil (55%)+trimethylolpropane ester (25%)+PAO4 (20%); methacrylate is selected as the anticoagulant;
e, 12 parts of the modified magnetic particles, 0.8 parts of dispersant, 68 parts of magnetic particles by weight are mixed with the mixture prepared by Step d, and dispersed by the micro jet homogenizer, in which the shear rate is≥10\hat{ }4s⁻¹, the pressure is 1500 bar, and three cycles of dispersion are carried out; the dispersant is hyperbranched polyesteramide; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

Example 3: A low-temperature-resistant magnetorheological fluid of this example is made of the following weight components: magnetic particles are selected from 68 parts of iron-nickel alloy powder (D50=3 μm); modified magnetic particles: 12 parts of SiO₂ aerogel coating+perfluorodecyltriethoxysilane grafted iron-nickel alloy powder; 18 parts of base carrier liquid: containing mineral oil (55%)+trimethylolpropane ester (25%)+PAO4 (20%); 0.8 parts of dispersant polyether modified siloxane; 1.2 parts of anticoagulant dodecyl naphthalene.

The preparation method for a low-temperature-resistant magnetorheological fluid of this example includes the following steps:
a, the magnetic particles are immersed in the ethanol solution of silane coupling agent (KH550), ultrasonically treated for 30 minutes, and dried at 80° C.; the magnetic particles are iron-nickel alloy powder;
b, the magnetic particles prepared in Step a are added with SiO₂ aerogel, stirred at 55° C. for 5 hours, and dried in supercritical fluid after aging for 24 hours to form a SiO₂ aerogel coating layer;
c, in the vacuum reaction vessel, the magnetic particles of the SiO₂ aerogel coating layer prepared by Step b are introduced into the perfluorodecyltriethoxysilane, and the modified magnetic particles are prepared by gas phase grafting at 150° C. for 2 hours;
specifically, SiO₂ precursor solution (TEOS as precursor, ammonia catalysis) was added drop by drop to the magnetic particles treated by Step a. The mass ratio of Fe—Ni alloy powder to SiO₂ precursor is 1:10-1:5. The weight ratio of this example is 1:7.5. The range can ensure the integrity and thickness controllability of the aerogel coating layer (controlled at 80 nm±5 nm), stirring at 55° C. for 5 hours, completing hydrolysis and condensation. After aging for 24 hours, supercritical drying is performed to form a SiO₂ aerogel coating layer with a thickness of 80 nm. By adjusting the silane concentration (2-5 vol %, this example is preferably 3.5 vol %), the grafting time is 3 hours, and the temperature is 150° C., the surface energy is reduced to <20 mN/m, and the contact angle is≥110°.
d, 18 parts of the base liquid and 1.2 parts of the anticoagulant by weight are ultrasonically mixed at 50° C. for 30 minutes to form a mixture; the base carrier liquid contains mineral oil (55%)+trimethylolpropane ester (25%)+PAO4 (20%); dodecyl naphthalene is selected as the anticoagulant;
e, 12 parts of the modified magnetic particles, 0.8 parts of dispersant, 68 parts of magnetic particles by weight are mixed with the mixture prepared by Step d, and dispersed by the micro jet homogenizer, in which the shear rate is≥10\hat{ }4s⁻¹, the pressure is 1500 bar, and three cycles of dispersion are carried out; the dispersant is polyether modified siloxane; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

Example 4: A low-temperature-resistant magnetorheological fluid of this example is made of the following weight components: magnetic particles are selected from 68 parts of carbonyl iron powder (D50=3 μm); modified magnetic particles: 12 parts of SiO₂ aerogel coating+perfluorodecyltriethoxysilane grafted carbonyl iron powder; 18 parts of base carrier liquid: containing mineral oil (55%)+trimethylolpropane ester (25%)+PAO4 (20%); 0.8 parts of dispersant polyether modified siloxane; 1.2 parts of anticoagulant dodecyl naphthalene.

The preparation method for a low-temperature-resistant magnetorheological fluid of this example includes the following steps:
a, the magnetic particles are immersed in the ethanol solution of silane coupling agent (KH550), ultrasonically treated for 30 minutes, and dried at 80° C.; the magnetic particles are carbonyl iron powder;
b, the magnetic particles prepared in Step a are added with SiO₂ aerogel, stirred at 55° C. for 5 hours, and dried in supercritical fluid after aging for 24 hours to form a SiO₂ aerogel coating layer;
c, in the vacuum reaction vessel, the magnetic particles of the SiO₂ aerogel coating layer prepared by Step b are introduced into the perfluorodecyltriethoxysilane, and the modified magnetic particles are prepared by gas phase grafting at 150° C. for 2 hours;
specifically, the SiO₂ precursor solution (TEOS as the precursor, ammonia as the catalyst) is added drop by drop to the magnetic particles treated by Step a. The mass ratio of carbonyl iron powder to SiO₂ precursor is 1:10-1:5, and the weight ratio is selected as 1:7.5 in this embodiment. This range can ensure the integrity and thickness controllability of the aerogel coating layer (controlled at 80 nm±5 nm). The mixture is stirred at 55° C. for 5 hours to complete the hydrolysis and condensation. After aging for 24 hours, the SiO₂ aerogel coating layer is formed by supercritical drying, and the thickness is 80 nm. By adjusting the silane concentration (2-5 vol %, this example is preferably 3.5 vol %), the grafting time is 3 hours, and the temperature is 150° C., the surface energy is reduced to <20 mN/m, and the contact angle is≥110°.
d, 18 parts of the base liquid and 1.2 parts of the anticoagulant by weight are ultrasonically mixed at 50° C. for 30 minutes to form a mixture; the base carrier liquid contains mineral oil (55%)+trimethylolpropane ester (25%)+PAO4 (20%); dodecyl naphthalene is selected as the anticoagulant;
e, 5 parts of the modified magnetic particles, 0.8 parts of dispersant, 75 parts of magnetic particles by weight are mixed with the mixture prepared by Step d, and dispersed by the micro jet homogenizer, in which the shear rate is≥10\hat{ }4s⁻¹, the pressure is 1500 bar, and three cycles of dispersion are carried out; the dispersant is polyether modified siloxane; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

Comparison case 1: Comparison case 1 verifies the effect of SiO₂ aerogel coating+fluorosilane grafting on particle dispersion, oxidation resistance, and interface stability. The magnetic particles are selected from 80 parts of carbonyl iron powder (D50=3 μm). Modified magnetic particles: none; 18 parts of base carrier liquid: containing dimethyl silicone oil 50%+pentaerythritol ester 30%+PAO620%; 0.5 parts of polyether modified siloxane dispersant; 1.5 parts of anticoagulant dodecyl naphthalene.

The preparation method for the propartal magnetorheological fluid includes the following steps:
a, the magnetic particles are immersed in the ethanol solution of silane coupling agent (KH550), ultrasonically treated for 30 minutes, and dried at 80° C.; the magnetic particles are carbonyl iron powder;
b, 18 parts of the base liquid and 1.5 parts of the anticoagulant by weight are ultrasonically mixed at 50° C. for 30 minutes to form a mixture; the base carrier liquid contains mineral oil (55%)+trimethylolpropane ester (25%)+PAO4 (20%); dodecyl naphthalene is selected as the anticoagulant;
c, 0.5 parts of dispersant and 80 parts of magnetic particles by weight are mixed with the mixture prepared by Step b, and dispersed by a micro-jet homogenizer, in which the shear rate is≥10\hat{ }4s⁻¹, the pressure is 1500 bar, and three cycles of dispersion are performed; the dispersant is polyether modified siloxane;
d, the liquid prepared by Step c is subjected to three-stage gradient cooling at 25° C., −20° C., and −40° C., and each stage is kept for 2 hours to obtain a magnetorheological fluid.

Comparison case 2: Comparison case 1 verifies the synergistic advantages of composite base carrier fluid (silicone oil+ester+PAO) in viscosity regulation, temperature adaptability, and lubricity compared with single silicone oil. The magnetic particles are selected from 68 parts of carbonyl iron powder (D50=3 μm). Modified magnetic particles: SiO₂ aerogel coating+perfluorodecyltriethoxysilane grafted carbonyl iron powder 12 parts; 18 parts of base carrier liquid: containing dimethyl silicone oil 100%; 0.5 parts of polyether modified siloxane dispersant; 1.5 parts of anticoagulant dodecyl naphthalene.

The preparation method for the propartal magnetorheological fluid includes the following steps:
a, the magnetic particles are immersed in the ethanol solution of silane coupling agent (KH550), ultrasonically treated for 30 minutes, and dried at 80° C.; the magnetic particles are carbonyl iron powder;
b, the magnetic particles prepared in Step a are added with SiO₂ aerogel, stirred at 55° C. for 5 hours, and dried in supercritical fluid after aging for 24 hours to form a SiO₂ aerogel coating layer.
c, in the vacuum reaction vessel, the magnetic particles of the SiO₂ aerogel coating layer prepared by Step b are introduced into the perfluorodecyltriethoxysilane, and the modified magnetic particles are prepared by gas phase grafting at 150° C. for 2 hours; the magnetic particles are prepared by Step a;
specifically, the SiO₂ precursor solution (TEOS as the precursor, ammonia as the catalyst) is added drop by drop to the magnetic particles treated by Step a. The mass ratio of carbonyl iron powder to SiO₂ precursor is 1:10-1:5, and the weight ratio is selected as 1:7.5 in this example. This range can ensure the integrity and thickness controllability of the aerogel coating layer (controlled at 80 nm±5 nm). After stirring at 55° C. for 5 hours, the hydrolysis condensation is completed, and the SiO₂ aerogel coating layer is formed after supercritical drying and aging for 24 hours, with a thickness of 80 nm. By adjusting the silane concentration (2-5 vol %, this example is preferably 3.5 vol %), the grafting time is 3 hours, and the temperature is 150° C., the surface energy is reduced to <20 mN/m, and the contact angle is≥110°.
d, 18 parts of the base liquid and 1.5 parts of the anticoagulant are ultrasonically mixed at 50° C. for 30 minutes to form a mixture; the base carrier liquid contains 100% dimethyl silicone oil; dodecyl naphthalene is selected as the anticoagulant;
e, 12 parts of the modified magnetic particles, 0.5 parts of dispersant, and a 68 parts of magnetic particles are mixed with the mixture prepared by Step d, and dispersed by a micro-jet homogenizer, in which the shear rate is≥10\hat{ }4s⁻¹, the pressure is 1500 bar, and three cycles of dispersion are performed; the dispersant is polyether modified siloxan; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

The actual settlement test is carried out on the magnetorheological fluid prepared by Example 1 to Example 4, Comparison case 1, and Comparison case 2. The test method is as follows: (1) The relationship between viscosity and shear rate is tested on the rheometer, and the point of the final shear rate is taken as the zero field viscosity of the magnetorheological fluid. (2) The relationship between shear stress and shear rate is tested on the rheometer, and the polarity is linearly fitted. The fitted intercept is taken as the shear yield stress of the magnetorheological fluid. (3) 50 mL of samples are prepared and dumped in a measuring cylinder. The samples are fixed and observed at 5 pm every day. The height of the upper clear liquid is measured. The anti-settlement rate=(upper clear liquid height/total height)*100%; the test results are shown in Table 1 below.

TABLE 1

| | Example | Example | Example | Example | Comparison | Comparison |
|---|---|---|---|---|---|---|
| Example performance | 1 | 2 | 3 | 4 | case 1 | case 2 |
| Zero-field viscosity at 25° C. | 0.25712 | 0.24177 | 0.19712 | 0.18189 | 0.79256 | 0.11268 |
| Zero-field viscosity at −40° C. | 0.27391 | 0.25657 | 0.22898 | 0.20212 | 0.98742 | 0.58395 |
| Shear yield stress (kPa) at | 2.57724 | 2.60286 | 2.59268 | 2.53233 | 1.71722 | 2.01673 |
| 25° C. 100 mT) | | | | | | |
| Shear yield stress (kPa) at | 79.12398 | 79.02536 | 80.81655 | 78.85026 | 58.34175 | 63.45391 |
| 25° C. 800 mT) | | | | | | |
| Shear yield stress (kPa) | 2.34917 | 2.36321 | 2.59303 | 2.57233 | 1.02116 | 1.59528 |
| at −40° C. 100 mT) | | | | | | |
| Shear yield stress (kPa) | 82.91177 | 77.08703 | 77.81491 | 76.85026 | 46.86773 | 55.5478 |
| at −40° C. 800 mT) | | | | | | |
| Settlement resistance at | 13.72 | 14.33 | 11.6 | 12.24 | 33.52 | 30.56 |
| 25° C. for 30 days (%) | | | | | | |
| Settlement resistance | 13.19 | 13.84 | 10.07 | 11.69 | 30.81 | 28.93 |
| at −40° C. for 30 days (%) | | | | | | |

It can be seen from the table that the magnetorheological fluid prepared by the invention has good low-temperature resistance, low zero field viscosity at −40° C., good anti-settlement, and high magnetic shear yield stress.

Example 5: A low-temperature-resistant magnetorheological fluid of this example is made of the following weight components: magnetic particles are selected from 70 parts of carbonyl iron powder (D50=5 μm); modified magnetic particles: 8 parts of SiO₂ aerogel coating+perfluorodecyltriethoxysilane grafted carbonyl iron powder; 20 parts of base carrier liquid: containing phenyl silicone oil (60%)+trimethylolpropane ester (20%)+PAO6 (20%); 0.6 parts of hyperbranched polyester amide dispersant; 1.4 parts of anticoagulant polymethacrylate.

The preparation method for a low-temperature-resistant magnetorheological fluid of this example includes the following steps:
a, the magnetic particles are immersed in the ethanol solution of silane coupling agent (KH550), ultrasonically treated for 30 minutes, and dried at 80° C.; the magnetic particles are carbonyl iron powder;
b, the magnetic particles prepared in Step a are added with SiO₂ aerogel, stirred at 55° C. for 5 hours, and dried in supercritical fluid after aging for 24 hours to form a SiO₂ aerogel coating layer;
c, in the vacuum reaction vessel, the magnetic particles of the SiO₂ aerogel coating layer prepared by Step b are introduced into the perfluorodecyltriethoxysilane, and the modified magnetic particles are prepared by gas phase grafting at 150° C. for 2 hours;
specifically, the SiO₂ precursor solution (TEOS as the precursor, ammonia as the catalyst) is added drop by drop to the magnetic particles treated by Step a. The mass ratio of carbonyl iron powder to SiO₂ precursor is 1:10-1:5, and the weight ratio is selected as 1:7.5 in this example. This range can ensure the integrity and thickness controllability of the aerogel coating layer (controlled at 80 nm±5 nm). The mixture is stirred at 55° C. for 5 hours to complete hydrolysis and condensation. After aging for 24 hours, the SiO₂ aerogel coating layer is formed by supercritical drying, and the thickness is 80 nm. By adjusting the silane concentration (2-5 vol %, this example is preferably 3.5 vol %), the grafting time is 3 hours, and the temperature is 150° C., the surface energy is reduced to <20 mN/m, and the contact angle is≥110°.
d, 20 parts of the base liquid and 1.4 parts of the anticoagulant by weight are ultrasonically mixed at 50° C. for 30 minutes to form a mixture; the base carrier liquid contains mineral oil (55%)+pentaerythritol ester (25%)+PAO4 (20%); polymethacrylate is selected as the anticoagulant;
e, 8 parts of the modified magnetic particles, 0.6 parts of dispersant, 70 parts of magnetic particles by weight are mixed with the mixture prepared by Step d, and dispersed by the micro jet homogenizer, in which the shear rate is≥10\hat{ }4s⁻¹, the pressure is 1500 bar, and three cycles of dispersion are carried out; the dispersant is polyether modified siloxane; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

Example 6: A low-temperature-resistant magnetorheological fluid of this example is made of the following weight components: magnetic particles are selected from 68 parts of cobalt powder (D50=5 μm); modified magnetic particles: 12 parts of SiO₂ aerogel coating+perfluorodecyltriethoxysilane grafted cobalt powder; 18 parts of base carrier liquid: containing phenyl silicone oil (45%)+trimethylolpropane ester (35%)+PAO4 (20%); 0.6 parts of dispersant polyether modified siloxane; 1.2 parts of anticoagulant dodecyl naphthalene.

The preparation method for a low-temperature-resistant magnetorheological fluid of this embodiment includes the following steps:
a, the magnetic particles are immersed in the ethanol solution of silane coupling agent (KH550), ultrasonically treated for 30 minutes, and dried at 80° C.; the magnetic particles are cobalt powder;
b, the magnetic particles prepared in Step a are added with SiO₂ aerogel, stirred at 55° C. for 5 hours, and dried in supercritical fluid after aging for 24 hours to form a SiO₂ aerogel coating layer;
c, in the vacuum reaction vessel, the magnetic particles of the SiO₂ aerogel coating layer prepared by Step b are introduced into the perfluorodecyltriethoxysilane, and the modified magnetic particles are prepared by gas phase grafting at 150° C. for 2 hours;
specifically, the SiO₂ precursor solution (TEOS as the precursor, catalyzed by ammonia) is added drop by drop to the magnetic particles treated by Step a, and the mass ratio of cobalt powder to SiO₂ precursor is 1:10-1:5. In this example, the weight ratio is 1:8.5, constant temperature stirring at 55° C. for 5 hours, complete hydrolysis and condensation, and supercritical drying after aging for 24 hours to form a SiO₂ aerogel coating layer with a thickness of 90 nm. By adjusting the silane concentration (2-5 vol %, this example is preferably 3.5 vol %), the grafting time is 3 hours, and the temperature is 150° C., the surface energy is reduced to <20 mN/m, and the contact angle is≥110°.
d, 18 parts of the base liquid and 1.2 parts of the anticoagulant by weight are ultrasonically mixed at 50° C. for 30 minutes to form a mixture; the base carrier liquid contains phenyl silicone oil (45%)+pentaerythritol ester (35%)+PAO4 (20%); dodecyl naphthalene is selected as the anticoagulant;
e, 12 parts of the modified magnetic particles, 0.8 parts of dispersant, 68 parts of magnetic particles by weight are mixed with the mixture prepared by Step d, and dispersed by the micro jet homogenizer, in which the shear rate is≥10\hat{ }4s⁻¹, the pressure is 1500 bar, and three cycles of dispersion are carried out; the dispersant is polyether modified siloxane; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

Example 7: A low-temperature-resistant magnetorheological fluid of this example is made of the following weight components: magnetic particles are selected from 68 parts of iron-nickel alloy powder (D50=5 μm); modified magnetic particles: SiO₂ aerogel coating+perfluorodecyltriethoxysilane grafted iron-nickel alloy powder 11.5 parts; base carrier liquid 18 parts: containing mineral oil (55%)+trimethylolpropane ester (25%)+PAO4 (20%); dispersant polyether modified siloxane 0.7 parts; anticoagulant dodecyl naphthalene 1.8 parts.

The preparation method for a low-temperature-resistant magnetorheological fluid of this embodiment includes the following steps:
The magnetic particles were immersed in the ethanol solution of silane coupling agent (KH550), ultrasonically treated for 30 minutes, and dried at 80° C.; the magnetic particles are iron-nickel alloy powder;
the magnetic particles prepared in step a were added with SiO₂ aerogel, stirred at 55° C. for 5 hours, and dried in supercritical fluid after aging for 24 hours to form a SiO₂ aerogel coating layer.

In the vacuum reaction vessel, the magnetic particles of the SiO₂ aerogel coating layer prepared by the b step were introduced into the perfluorodecyltriethoxysilane, and the modified magnetic particles were prepared by gas phase grafting at 150° C. for 2 hours;

specifically, the SiO₂ precursor solution (TEOS as the precursor, catalyzed by ammonia) was added drop by drop to the magnetic particles treated by step a. The mass ratio of iron-nickel alloy powder to SiO₂ precursor was 1:10-1:5. In this example, the weight ratio is 1:7.5,55° C. constant temperature stirring for 5 hours, the hydrolysis condensation was completed, and the supercritical drying was performed after aging for 24 hours to form a SiO₂ aerogel coating layer with a thickness of 80 nm. By adjusting the silane concentration (2-5 vol %, this example is preferably 3.5 vol %), the grafting time is 3 hours, and the temperature is 150° C., the surface energy is reduced to <20 mN/m, and the contact angle is≥110°.
d, 18 parts of the base liquid and 1.8 parts of the anticoagulant by weight are ultrasonically mixed at 50° C. for 30 minutes to form a mixture; the base carrier liquid contains phenyl silicone oil (45%)+pentaerythritol ester (35%)+PAO4 (20%); dodecyl naphthalene is selected as the anticoagulant;
e, 11.5 parts of the modified magnetic particles, 0.7 parts of dispersant, 68 parts of magnetic particles by weight are mixed with the mixture prepared by Step d, and dispersed by the micro jet homogenizer, in which the shear rate is≥10\hat{ }4s⁻¹, the pressure is 1500 bar, and three cycles of dispersion are carried out; the dispersant is polyether modified siloxane; the magnetic particles are prepared by Step a;
f, the liquid prepared by Step e is subjected to three-stage gradient cooling at 25° C., −20° C., and −40° C., and each stage is kept for 2 hours to obtain a magnetorheological fluid.

Example 8: The difference between Example 5 and Example 8 is that the modified magnetic particles are modified to 15 parts, the magnetic particles are modified to 65 parts, and the composition of the base carrier liquid is modified to mineral oil (50%)+trimethylolpropane ester (25%)+PAO6 (25%); the preparation method steps do not change;
Comparison case 3: The difference from Example 5 is that the base carrier liquid is changed to 21.4 parts, and no anticoagulant is used; the preparation method steps do not change.
Comparison case 4: The difference from Example 5 is that the base liquid is a single ester, the pentaerythritol ester is 100%, and the preparation method and steps do not change.

The actual settlement test is carried out on the magnetorheological fluid prepared from Example 5 to Example 8, Comparison case 3, and Comparison case 4. The test results are shown in Table 2 below.

TABLE 2

| | Example | Example | Example | Example | Comparison | Comparison |
|---|---|---|---|---|---|---|
| Example performance | 5 | 6 | 7 | 8 | case 3 | case 4 |
| Zero-field viscosity at 25° C. | 0.23812 | 0.24217 | 0.20812 | 0.19523 | 0.31522 | 0.41821 |
| Zero-field viscosity at 40° C. | 0.25521 | 0.25834 | 0.22512 | 0.21022 | 1.20312 | 0.89231 |
| Shear yield stress (kPa) at | 2.36324 | 2.85236 | 2.62268 | 2.78453 | 1.52231 | 1.85673 |
| 25° C. 100 mT) | | | | | | |
| Shear yield stress (kPa) at | 78.31328 | 76.51436 | 80.31215 | 83.22621 | 52.34175 | 65.23391 |
| 25° C. 800 mT) | | | | | | |
| Shear yield stress (kPa) at | 2.12317 | 2.43321 | 2.38303 | 2.52233 | 0.78612 | 1.12342 |
| 40° C. 100 mT) | | | | | | |
| Shear yield stress (kPa) at | 75.91217 | 73.93703 | 78.12491 | 79.85026 | 32.67534 | 48.56278 |
| 40° C. 800 mT) | | | | | | |
| Settlement resistance at | 13.52 | 14.21 | 12.12 | 10.80 | 38.72 | 28.56 |
| 25° C. for 30 days (%) | | | | | | |
| Settlement resistance | 13.01 | 13.82 | 11.72 | 10.32 | 41.2 | 26.93 |
| at −40° C. for 30 days (%) | | | | | | |

Comprising Comparison case 3 with Example 5-Example 8, the lack of anticoagulant significantly increases the zero-field viscosity at −40° C., indicating that the anticoagulant significantly reduces the low-temperature viscosity by inhibiting the crystallization of the base carrier liquid. The shear stress of Comparison case 3 at 800 mT is only 52.34 kPa (25° C.) and 32.67 kPa (−40° C.), which is much lower than 75-83 kPa of Example 5-8. The anticoagulant improves the fluidity and promotes the rapid reorganization of the particle chain under the magnetic field. The 30-day settlement rate of Comparison case 3 is as high as 38.7% (25° C.) and 41.2% (−40° C.), and Example 5-Example 8 are all≤15%. The anticoagulant reduces the viscosity fluctuation of the carrier liquid and inhibits particle agglomeration.

Comparing Comparison case 4 with Example 5-Example 8, it can be seen that the composite base carrier fluid has a synergistic effect and helps to optimize the fluidity. The shear stress of Comparison case 4 at 800 mT is 65.23 kPa (25° C.) and 48.56 kPa (−40° C.), and Example 5-Example 8≥75 kPa, the composite carrier fluid guarantees the dynamic recombination efficiency of the particle chain; the settlement rate of Comparison case 4 (28.5%) is significantly higher than that of Example 5-Example 8 (≤15%), and the composite carrier liquid reduces particle settlement through viscosity balance.

Compared with Example 5 and Example 1, the difference variable is that the particle size of carbonyl iron powder becomes larger, and the weight fraction of base carrier liquid and magnetic particles increases. The viscosity of the product of Example 5 at 25° C. increases slightly to 0.238 Pa·s (original 0.257), and the fluidity of large particle size decreases slightly. The shear stress is maintained at 78.3 kPa (800 mT), and the increase of particle size has little effect on magnetic properties.

Compared with Example 1, the magnetic particles are replaced by cobalt powder in Example 6, the polarity of esters in the carrier liquid increases, the permeability of cobalt powder is slightly lower, and the shear stress at 800 mT decreases to 76.5 kPa (compared with case 1, 79.1 kPa); the polarity of esters was enhanced, and the viscosity at −40° C. is 0.258 Pa·s, which was better than that of implementation case 1 (0.273 Pa·s).

Compared with Example 1, the magnetic particle of Example 7 is an iron-nickel alloy powder, and the carrier liquid is replaced by a mineral oil system. The magnetic properties of the iron-nickel alloy are excellent, and the shear stress at 800 mT reaches 80.3 kPa (better than Example 1). The viscosity of mineral oil is slightly higher, and the settlement rate is 12.1% (compared with 13.7% in Example 1).

Compared with Example 8 and Example 1, the polarity of modified magnetic particles increased, the base carrier liquid decreased, and the modified particles improved the interface stability. The shear stress of 800 mT reached 83.2 kPa (the highest value). The reduction of the base liquid leads to a decrease in the settlement rate to 10.8% (optimal value).

According to the above examples and the comparison cases, the composite system of anticoagulant and base carrier liquid is the core of low-temperature performance: the absence of anticoagulant (Comparison case 3) or single base carrier liquid (Comparison case 4) leads to a sharp increase in viscosity and a weakening of magnetic response, and the composite base carrier liquid+anticoagulant synergistically optimizes low-temperature fluidity and stability.

The type and particle size of magnetic particles affect the magnetic response and fluidity: the permeability of cobalt powder is slightly lower, and the performance of iron-nickel alloy is better; the effect of large particle size (5 μm) on fluidity is controllable.

The polarity of modified particles and coating process are the key: increasing the polarity of modified particles (Example 8) can improve interface stability, reduce settlement, and enhance magnetic response.

The universality verification of Examples 1-8: all examples meet viscosity≤0.3 Pa·s, shear stress≥75 kPa, settlement rate≤15% at −40° C., which proves the reliability and scalability of formulation design in extreme low-temperature scenarios.

Example 9: The difference between Example 5 and Example 9 is that the magnetic particle size: D50=2 μm; hyperbranched polyester amide is selected as dispersant, the hyperbranched polyester amide is 0.9 parts; anticoagulant: 1.1 parts of dodecyl naphthalene; magnetic particles: 70 parts of carbonyl iron powder; modified magnetic particles: 10 parts; the preparation methods and steps do not change.

Example 10: The difference between Example 5 and Example 10 is that anticoagulant: 1.5 parts of polymethacrylate; dispersant: 0.5 parts of hyperbranched polyesteramide; base carrier liquid: phenyl silicone oil (50%)+trimethylolpropane ester (30%)+PAO6 (20%)→18 parts; modified magnetic particles: 12 parts.

The preparation method is to modify the aerogel coating time to 6 hours and the coating thickness to 100 nm.

Example 11: The difference between Example 5 and Example 11 is that magnetic particles: 70 parts of nickel powder, 20 parts of base carrier liquid: mineral oil (50%)+pentaerythritol ester (30%)+PAO6 (20%);
the preparation method steps do not change.

Example 12: The difference between Example 5 and Example 12 is that magnetic particles: 68 parts; modified magnetic particles: 12 parts; 18 parts of base carrier liquid: dimethyl silicone oil (35%)+trimethylolpropane ester (40%)+PAO4 (25%);
the preparation method steps do not change.

Comparison case 5: The difference from Example 1 is that the dispersant is not used and the remaining parts by weight are adjusted. Magnetic particles: 68 parts; modified magnetic particles: 12 parts; base carrier liquid: 18.5 parts; anticoagulant: 1.5 parts;
the preparation method steps do not change.

Comparison case 6: the difference from Example 1 is that the original magnetic particles are not applicable, and the modified magnetic particles are 80 parts; the preparation method steps do not change.

The actual settlement test is carried out on the magnetorheological fluid prepared by Example 9 to Example 12, Comparison case 5, and Comparison case 6. The test results are shown in Table 3 below.

TABLE 3

| | Example | Example | Example | Example | Comparison | Comparison |
|---|---|---|---|---|---|---|
| Example performance | 9 | 10 | 11 | 12 | case 5 | case 6 |
| Zero-field viscosity at 25° C. | 0.252243 | 0.21843 | 0.24522 | 0.26313 | 0.68522 | 0.33221 |
| Zero-field viscosity at −40° C. | 0.27312 | 0.23624 | 0.26213 | 0.27821 | 1.50212 | 0.41511 |
| Shear yield stress (kPa) at | 2.95324 | 2.68236 | 2.78228 | 2.88153 | 1.45231 | 1.92173 |
| 25° C. 100 mT) | | | | | | |
| Shear yield stress (kPa) at | 76.81218 | 79.61436 | 77.53153 | 76.12621 | 46.32125 | 62.15121 |
| 25° C. 800 mT) | | | | | | |
| Shear yield stress (kPa) | 2.61217 | 2.41211 | 2.50023 | 2.56133 | 0.82112 | 1.38342 |
| at −40° C. 100 mT) | | | | | | |
| Shear yield stress (kPa) | 74.52127 | 77.23503 | 75.22191 | 73.55026 | 28.75341 | 49.67278 |
| at −40° C. 800 mT) | | | | | | |
| Settlement resistance at | 14.51 | 12.32 | 13.21 | 15.21 | 44.62 | 22.71 |
| 25° C. for 30 days (%) | | | | | | |
| Settlement resistance | 14.01 | 11.92 | 12.82 | 14.62 | 42.82 | 20.53 |
| at −40° C. for 30 days (%) | | | | | | |

Compared with Examples 1-12 and Comparison case 5, due to the lack of dispersant, the particles are seriously agglomerated due to the van der Waals force, resulting in a sharp increase in viscosity; the shear stress of 800 mT is only 46.32 kPa, and the particle chain is difficult to be effectively recombined. The 30-day settlement rate exceeds 44%, which is much higher than the 13.7% of Example 1.

Compared with Comparison case 6 and Examples 1-12, the polarity of SiO₂ aerogel in the modified particles is high (80 parts), which dilutes the volume of the magnetic phase, resulting in a shear stress of 800 mT reduced to 62.15 kPa. The SiO₂ layer between the particles is thickened, the interface friction is increased, and the viscosity at −40° C. is increased. The 30-day settlement rate is 22.7%, and the difference in modified particle density leads to a decrease in dispersion stability.

Compared with Example 1, the particle size of magnetic particles in Example 9 is reduced to 2 μm, and the amount of dispersant is increased to 0.9 parts. The specific surface area of small particles increases, and the formation speed of flux linkage is accelerated. The shear stress of 800 mT reaches 76.8 kPa (slightly lower than 79.1 kPa of Example 1). The increase of dispersant dosage inhibits the settlement of particles, and the settlement rate is 14.5% in 30 days.

Compared with Example 1, the sol-gel time of Example 10 is extended to 6 hours, and the thickness of the coating layer is increased to 100 nm. The thicker SiO₂ layer enhances the thermal expansion buffer, and the viscosity at −40° C. decreases to 0.236 Pa·s. The too-thick cladding layer slightly hinders the flux linkage recombination.

Compared with Example 1, the magnetic particles in Example 11 are replaced by nickel powder from carbonyl iron powder; the permeability of nickel powder is slightly lower, and the shear stress at 800 mT is reduced to 77.9 kPa (compared with 79.1 kPa of Example 1). The density of nickel powder is high, and the settlement rate is 13.1% (close to 13.7% of Example 1).

Compared with Example 1, the polarity of esters in the base carrier liquid increases to 40% (original 30%) in Example 12; the polar enhancement of esters inhibits low-temperature crystallization, and the viscosity at −40° C. is 0.278 Pa·s (compared with 0.273 Pas in Example 1). flexibility optimization of the ester molecular chain, 800 mT shear stress is 76.1 kPa (slightly lower than Example 1).

The core problem of Comparison cases 5-6: the lack of dispersant or the imbalance of original/modified particle ratio leads to a cliff-like decline in performance, which verifies the key role of dispersant and particle ratio.

The optimization direction of Examples 9-12: The flexibility of formulation design is verified by adjusting the particle size, coating process, base carrier liquid composition, and other variables. All the examples meet the core indicators (viscosity at −40° C.≤0.3 Pa·s, shear stress≥75 kPa, settlement rate≤15%).

The difference between Examples 9-12 and Example 1: on the premise of maintaining the basic performance, the slight influence of different processes or components on the performance is explored through single variable adjustment, which provides a variety of choices for practical application.

Example 13: the same weight as Example 1, the preparation method changes: the difference is that the aerogel coating time is shortened to 3 hours (originally 5 hours), and the precursor ratio is adjusted to 1:5 (carbonyl iron powder: SiO₂ precursor); coating thickness: 50 nm (originally 80 nm).

Example 14: the same weight fraction as Example 1, the preparation method changes: fluorine-containing silane grafting time extends to 4 hours (originally 2 hours), grafting temperature is maintained at 150° C.; silane concentration: 5 vol % (originally 3.5 vol %).

Example 15: the same weight fraction as Example 1, the preparation method changes: Step b: the precursor is replaced with MTES, hydrolyzed, and condensed under acidic conditions (hydrochloric acid to adjust pH=4), the aging time is still 24 hours, and the porosity is 85%.

Example 16: the same weight fraction as Example 1, the composition ratio of the base carrier liquid is modified to 30% mineral oil+20% dimethyl silicone oil+30% pentaerythritol ester+20% PAO6; the preparation method is not changed.

Example 17: the same weight fraction as Example 1, the preparation method changes: the gas phase grafting temperature is modified to 120° C., and other conditions remain unchanged.

Example 18: the same weight fraction as Example 1, the preparation method changes: the gas phase grafting temperature is modified to 135° C., and other conditions remain unchanged.

The actual settlement test is carried out on the magnetorheological fluid prepared from Example 13 to Example 18, and the test results are shown in Table 4 below.

TABLE 4

| | Example | Example | Example | Example | Example | Example |
|---|---|---|---|---|---|---|
| Performance Examples | 13 | 14 | 15 | 16 | 17 | 18 |
| Zero-field viscosity at 25° C. | 0.24843 | 0.25313 | 0.26122 | 0.26512 | 0.263121 | 0.26012 |
| Zero-field viscosity at −40° C. | 0.26821 | 0.27124 | 0.28213 | 0.29123 | 0.298322 | 0.28021 |
| Shear yield stress (kPa) at | 2.60324 | 2.72216 | 2.55128 | 2.58121 | 2.54143 | 2.61312 |
| 25° C. 100 mT) | | | | | | |
| Shear yield stress (kPa) at | 78.52118 | 80.62136 | 77.22353 | 77.91231 | 76.31243 | 78.81251 |
| 25° C. 800 mT) | | | | | | |
| Shear yield stress (kPa) | 2.35217 | 2.48121 | 2.30023 | 2.32123 | 2.22134 | 2.31232 |
| at −40° C. 100 mT) | | | | | | |
| Shear yield stress (kPa) | 76.81127 | 78.32103 | 75.11191 | 75.42134 | 73.5251 | 80.53121 |
| at −40° C. 800 mT) | | | | | | |
| Settlement resistance at | 14.51 | 12.51 | 15.61 | 14.23 | 15.12 | 14.01 |
| 25° C. for 30 days (%) | | | | | | |
| Settlement resistance | 14.31 | 12.12 | 15.02 | 13.81 | 14.62 | 13.53 |
| at −40° C. for 30 days (%) | | | | | | |

Compared with Example 1, the settlement rate of Example 13 is slightly higher than that of Example 1 (14.8% vs 13.7%) due to the thinner coating layer, which reduces the thermal expansion buffer capacity. The 800 mT shear stress is maintained at 78.5 kPa (compared with the 79.1 kPa of Example 1), and the performance difference can be ignored.

Compared with Example 1, higher silane concentration and longer grafting time increase the contact angle, enhance hydrophobicity, and decrease the settlement rate (12.5% vs 13.7%) in Example 14. The shear stress is increased to 80.6 kPa (79.1 kPa for example 1), and the optimization of interface lubricity promoted the recombination of particle chains.

Compared with Example 1, the precursor and catalytic system in Example 15 change: the porosity of SiO₂ aerogel generated by MTES is slightly lower (85% vs 90%), resulting in slightly higher low-temperature viscosity; the settlement rate is 15.6% (compared with 13.7% in Example 1), and the decrease of porosity weakens the stability of particle dispersion.

Compared with Example 1, the low-temperature fluidity of mineral oil in Example 16 is slightly lower than that of pure silicone oil, resulting in the viscosity of −40° C. increased from 0.273 Pa·s to 0.291 Pa·s, but still meets the core index of ≤0.3 Pa·s. The lubricity of mineral oil is slightly worse. The shear stress of 800 mT is reduced from 79.1 kPa to 77.9 kPa, but it is still within the qualified range (≥75 kPa). The mineral oil density and particle matching are slightly lower, and the 30-day settlement rate increases from 13.7% to 14.2%, but it does not deteriorate significantly. The introduction of mineral oil can reduce costs, and by adjusting the ratio of mineral oil to silicone oil (such as 20% mineral oil+50% silicone oil), it is possible to further balance performance and economy.

Example 17 and Example 18 respectively compared with Example 1, the grafting temperature becomes lower, the contact angle changes, and the viscosity at −40° C. decreases slightly; the interface bonding force is enhanced, the settlement rate is increased, and the hydrophobicity is improved to inhibit particle agglomeration.

Shortening the coating time or replacing the precursor can reduce the cost, but it is necessary to balance the anti-settling and fluidity; the enhanced grafting process (Example 14) significantly improves the hydrophobicity and magnetic response performance, which is the preferred solution for high-performance scenarios. Composition adjustment (Example 16): The partial replacement of silicone oil by mineral oil can reduce the cost of raw materials while maintaining the core performance indicators, which is suitable for cost-sensitive application scenarios; change the gas phase grafting temperature to change the hydrophobicity.

The viscosity≤0.3 Pa·s, shear stress≥75 kPa, and settlement rate≤15% are satisfied in all examples at −40° C., which proves the flexibility and reliability of the formulation design.

The above are the better examples of this application, which does not limit the scope of protection of this application. Therefore, the equivalent changes made according to the structure, shape, and principle of this application should be covered within the scope of protection of this application.

What is claimed is:

1. A low-temperature-resistant magnetorheological fluid, comprising components containing the following parts by weight: 60-75 parts of magnetic particles; 3-15 parts of modified magnetic particles; 10-25 parts of low-temperature base carrier liquid, wherein the low-temperature base carrier liquid comprises 40-60% silicone oil and/or mineral oil, 20-30% synthetic ester, 10-20% poly alpha olefin; 0.1-1.0 parts of dispersant; and 0.5-2.0 parts of anticoagulant;
wherein the modified magnetic particles are magnetic particles treated with SiO₂ aerogel coating and fluorine-containing silane grafting;
wherein the anticoagulant is selected from an alkyl naphthalene derivative or a polymethacrylate; and
wherein a contact angle of the fluorine-containing silane grafting of the modified magnetic particles is ≥110°.

2. The low-temperature-resistant magnetorheological fluid according to claim 1, wherein the SiO₂ aerogel coating thickness of the modified magnetic particles is 50-100 nm.

3. The low-temperature-resistant magnetorheological fluid according to claim 1, wherein the dispersant is selected from polyether modified siloxane or hyperbranched polyester amide.

4. The low-temperature-resistant magnetorheological fluid according to claim 1, wherein the particle size of the magnetic particles is 0.5-10 μm, and the magnetic particles are selected from at least one of carbonyl iron powder, cobalt powder, and nickel powder.

5. A preparation method for the low-temperature-resistant magnetorheological fluid according to claim 1, comprising the following steps:
a, immersing the magnetic particles in an ethanol solution of silane coupling agent, ultrasonically treating for 30 minutes, and drying at 80° C.;
b, adding the magnetic particles prepared in Step a with SiO₂ aerogel, stirred at 50-60° C. for 4-6 hours, and drying by supercritical drying after aging for 24 hours to form a SiO₂ aerogel coating layer;
c, in a vacuum reaction vessel, introducing the magnetic particles of the SiO₂ aerogel coating layer prepared by Step b into the fluorine-containing silane, and grating the gas phase at 120-150° C. for 2-4 hours to obtain the modified magnetic particles;
d, ultrasonic mixing 10-25 parts of the base liquid and 0.5-2.0 parts of the anticoagulant by weight at 40-60° C. for 30 minutes to form a mixture;
e, mixing 3-15 parts of the modified magnetic particles, a dispersant of 0.1-1.0 parts, and a magnetic particle of 60-75 parts by weight with the mixture prepared by Step d and dispersing by a micro-jet homogenizer;
f, the liquid prepared by Step e is subjected to gradient cooling treatment to obtain a magnetorheological fluid.

6. The preparation method according to claim 5, wherein in Step f, three-stage gradient cooling of 25° C., −20° C., and −40° C. is adopted, and each stage is kept for 2 hours.

7. The preparation method according to claim 5, wherein in Step e, 60-75 parts of magnetic particles are processed by Step a.

8. The preparation method according to claim 5, wherein when the micro-jet homogenizer is used for dispersion in Step e, the shear rate is ≥10\hat{ }4s⁻¹, the pressure is 1500 bar, and three cycles of dispersion are performed.
